(19) United States
(12) Patent Application Publication
(10) Pub. No.: US 2025/0167560 A1
(43) Pub. Date: May 22, 2025

(54) FAST CALCULATION METHOD AND DEVICE FOR DYNAMIC RESILIENCE REGION OF URBAN POWER SYSTEM

(71) Applicant: Peking University, Beijing (CN)

(72) Inventors: Jianxiao WANG, Beijing (CN); Yiyang SONG, Beijing (CN); Yang ZOU, Beijing (CN); Jing DAI, Beijing (CN); Feng GAO, Beijing (CN); Jie SONG, Beijing (CN)

(21) Appl. No.: 18/953,276

(22) Filed: Nov. 20, 2024

(30) Foreign Application Priority Data
Nov. 20, 2023 (CN) 202311553499.4

(51) Int. Cl. H02J 3/46; H02J 3/00; H02J 3/14

(52) U.S. Cl. CPC H02J 3/46; H02J 3/00125; H02J 3/144; H02J 2203/20

(57) ABSTRACT

A fast calculation method for dynamic resilience region of an urban power system includes: constructing an urban power system three-stage model applicable for multiple types of public safety events by considering security constraints before, during, and after a disaster, to minimize a three-stage operation cost and a load shedding amount of urban power grid; based on the urban power system three-stage model, defining a boundary between a resilience region and a non-resilience region as a resilience cut line, and removing the non-resilience region from the outside to quickly obtain the dynamic resilience region; and based on the urban power system three-stage model, using the shortest distance from a current operating point to the boundary of the dynamic resilience region to represent a dynamic safety margin of urban power system under a current disaster prediction scenario.

### CROSS REFERENCE TO RELATED APPLICATIONS

This application claims priority to Chinese Application No. 202311553499.4, filed on Nov. 20, 2023, the entire disclosure of which is hereby incorporated herein by reference.

### TECHNICAL FIELD

The disclosure belongs to an urban power system resilience field, more particular to techniques for assessing and improving the resilience of urban power systems based on dynamic resilience region depiction.

### BACKGROUND

The existing research on resilience of an urban power system mainly focus on change of a single indicator before and after an accident. However, the impact of extreme events on urban power grid security is not a “one-dimensional” problem, and the existing researches have not taken into account coupling of multiple indicators. There are complex coupling mechanisms between different indicators. The fragmented pursuit of a single indicator may affect the realization of other indicators, and is difficult to reflect the safety margin at the power flow operating point. The disclosure provides a method for assessing a resilience level of an urban power system based on a dynamic resilience region, which depicts a coupling situation of multiple resilience indicators, and quantifies and represents the safety margin of the urban power system in the power flow operating state. It also proposes a fast calculation method for dynamic resilience region of urban power system.

### SUMMARY

The disclosure aims at solving one of the technical problems in the related art at least to some extent.

In view of this, an object of the disclosure is to provide a fast calculation method for dynamic resilience region of an urban power system, which can be used for safety early warning of the urban power system.

To achieve the above purpose, a first aspect of embodiments of the disclosure provides a fast calculation method for dynamic resilience region of an urban power system. The method includes:
constructing an urban power system three-stage model applicable for multiple types of public safety events by considering security constraints before, during, and after a disaster, to minimize a three-stage operation cost and a load shedding amount of urban power grid;
based on the urban power system three-stage model, defining a boundary between a resilience region and a non-resilience region as a resilience cut line, and removing the non-resilience region from the outside to quickly obtain the dynamic resilience region; and
based on the urban power system three-stage model, using the shortest distance from a current operating point to the boundary of the dynamic resilience region to represent a dynamic safety margin of the urban power system under a current disaster prediction scenario.

Moreover, according to the above embodiments of the disclosure, the fast calculation method for dynamic resilience region of urban power system has the following additional technical features.

In an embodiment of the disclosure, constructing the urban power system three-stage model applicable for multiple types of public safety events by considering the security constraints before, during, and after the disaster, includes:
minimizing an operating cost and a load shedding value of the urban power system three-stage model:

$$min {\sum }_{t} ( {\sum }_{g} {α}_{g} {P}_{g , t}^{2} + {β}_{g} {P}_{g , t} + {γ}_{g} {v}_{g , t} + {\sum }_{j} {c}_{j} {P}_{j , c , t}^{load} ) \qquad ( 1 )$$

where α_{g}, β_{g} and γ_{g} represent the cost coefficients for generating set g, respectively, cⱼ represents a cost coefficient for loss-of-load of load j. P_{g,t} represents an active output of the generating set g at a time t, P_{j,c,t}^{load} represents a load shedding amount loaded by node j at the tine t, v_{g,t} represents an on/off state of the generating set g at the time t, and if v_{g,t}=0, it indicates that the generating set is off, otherwise, it indicates that the generating set is on.

In an embodiment of the disclosure, considering the security constraints before, during, and after the disaster, includes:
before the disaster, considering power flow constraints, node balance and generating set output constraints, wherein linearizing the power flow constraints are as follows:

$${P}_{ij , t} = {G}_{ij} ( {U}_{i , t} - {U}_{j , t} ) / 2 - {B}_{ij} ( {θ}_{i , t} - {θ}_{j , t} ) ∀ t ∈ {ϕ}^{T} , ∀ i ∈ {ϕ}^{N} \qquad ( 2 )$$

$${Q}_{ij , t} = - {G}_{ij} ( {θ}_{i , t} - {θ}_{j , t} ) - {B}_{ij} ( {U}_{i , t} - {U}_{j , t} ) / 2 ∀ t ∈ {ϕ}^{T} , ∀ i ∈ {ϕ}^{N} \qquad ( 3 )$$

where U_{i,t} and U_{j,t} represent voltage magnitudes at nodes i and j at the time t respectively, θ_{i,t} and θ_{j,t} represent voltage phase angles at the nodes i and j at the time t, Gᵢⱼ and Bᵢⱼ represent conductance and susceptance values between the nodes i and j, respectively, ϕ^{N} represents a set of power system nodes, and ϕ^{T} represents a set of time nodes, equations (2) and (3) describe calculation methods of active and reactive power flows of a line ij, respectively;
voltage and phase angle constraints are shown in equations (4) and (5):

$${U}_{min} \leq {U}_{i , t} \leq {U}_{max} ∀ t ∈ {ϕ}^{T} , ∀ i ∈ {ϕ}^{N} \qquad ( 4 )$$

$${θ}_{min} \leq {θ}_{i , t} \leq {θ}_{max} ∀ t ∈ {ϕ}^{T} , ∀ i ∈ {ϕ}^{N} \qquad ( 5 )$$

where Uₘᵢₙ and Uₘₐₓ represent lower and upper limits of voltage amplitude, respectively, and θₘᵢₙ and θₘₐₓ represent upper and lower limits of voltage phase angle, respectively;
power system power flow constraints are shown in equations (6)-(9):

$$- {u}_{ij , t}^{line} {F}_{ij , max} \leq {P}_{ij , t} \leq {u}_{ij , t}^{line} {F}_{ij , max} ∀ t ∈ {ϕ}^{T} , ∀ ij ∈ {ϕ}^{L} \qquad ( 6 )$$

$$- {u}_{ij , t}^{line} {F}_{ij , max} \leq {Q}_{ij , t} \leq {u}_{ij , t}^{line} {F}_{ij , max} ∀ t ∈ {ϕ}^{T} , ∀ ij ∈ {ϕ}^{L} \qquad ( 7 )$$

$$- \sqrt{2} {u}_{ij , t}^{line} {F}_{ij , max} \leq {P}_{ij , t} + {Q}_{ij , t} \leq \sqrt{2} {u}_{ij , t}^{line} {F}_{ij , max} ∀ t ∈ {ϕ}^{T} , ∀ ij ∈ {ϕ}^{L} \qquad ( 8 )$$

$$- \sqrt{2} {u}_{ij , t}^{line} {F}_{ij , max} \leq {P}_{ij , t} - {Q}_{ij , t} \leq \sqrt{2} {u}_{ij , t}^{line} {F}_{ij , max} , ∀ t ∈ {ϕ}^{T} , ∀ ij ∈ {ϕ}^{L} \qquad ( 9 )$$

where F_{ij,max} represents an upper limit of power flow of the line ij; u_{ij,t}^{line} represents a line status, if u_{ij,t}^{line}=0, it indicates that the line is disconnected, if u_{ij,t}^{line}=1, it indicates that the line status is normal, and ϕ^{L} represents a set of lines;
node power balance constraints are shown:

$${\sum }_{j ∈ {ϕ}^{N}} {P}_{ji , t} - {\sum }_{j ∈ {ϕ}^{N}} {P}_{ij , t} + {\sum }_{g ∈ {ϕ}^{G} ( i )} {P}_{g , t} = {P}_{i , 0}^{load} - {P}_{i , c , t}^{load} ∀ t ∈ {ϕ}^{T} , ∀ i ∈ {ϕ}^{N} \qquad ( 10 )$$

$${\sum }_{j ∈ {ϕ}^{N}} {Q}_{ji , t} - {\sum }_{j ∈ {ϕ}^{N}} {Q}_{ij , t} + {\sum }_{g ∈ {ϕ}^{G} ( i )} {Q}_{g , t} = {Q}_{i , 0}^{load} - {Q}_{i , c , t}^{load} ∀ t ∈ {ϕ}^{T} , ∀ i ∈ {ϕ}^{N} \qquad ( 11 )$$

where P_{j,0}^{load} and Q_{j,0}^{load} represent active and reactive power demands of the node j, respectively, P_{g,t} and Q_{g,t} represent active and reactive outputs of the generator g at the time t, respectively, and ϕ^{N} represents a set of generating sets, P_{j,c,t}^{load} and Q_{j,c,t}^{load} represent load shedding amounts of node j at the time t, which is 0 before the disaster;
generating set output constraint and load shedding constraint are shown:

$${v}_{g , t} {P}_{g , min} \leq {P}_{g , t} \leq {v}_{g , t} {P}_{g , max} ∀ t ∈ [ 1 , {t}_{end} ] , ∀ g ∈ {ϕ}^{G} \qquad ( 12 )$$

$${v}_{g , t} {Q}_{g , min} \leq {Q}_{g , t} \leq {v}_{g , t} {Q}_{g , max} ∀ t ∈ {ϕ}^{T} , ∀ g ∈ {ϕ}^{G} \qquad ( 13 )$$

$${R}_{g} \leq {P}_{g , t} - {P}_{g , t - 1} \leq {R}_{g} ∀ t ∈ {ϕ}^{T} , ∀ g ∈ {ϕ}^{G} \qquad ( 14 )$$

where v_{i,t} represents an operating state of a generating set i at the time t, and if v_{i,t}=1, it indicates the generating set is operating normally, otherwise, the generating set is shut down; P_{g,min} and P_{g,max} represent the minimum and maximum outputs of the generating set respectively; equations (12) and (13) represent the generating set output constraints, and equation (14) represents a generating set climbing constraint.

Further, in an embodiment of the disclosure, considering the security constraints before, during, and after the disaster, includes:
under the influence of the disaster, introducing a binary variable u_{ij,t}^{d} to represent a line damage condition; if u_{ij,t}^{d}=0, it indicates that the line is damaged and disconnected due to the disaster; and introducing a binary variable u_{ij,t}^{d} to represent an active disconnection of the line; if u_{ij,t}^{p}=0, it indicates that the line ij is actively, disconnected to avoid fault propagation, in which logic constraints of u_{ji,t}^{line}, u_{ij,t}^{d} and u_{ij,t}^{p} are as follows:

$${u}_{ij , t}^{line} \leq {u}_{ij , t}^{p} ∀ ij ∈ {ϕ}^{L} , ∀ t ∈ {ϕ}^{T} \qquad ( 15 )$$

$${u}_{ij , t}^{line} \leq {u}_{ij , t}^{d} ∀ ij ∈ {ϕ}^{L} , ∀ t ∈ {ϕ}^{T} \qquad ( 16 )$$

$${u}_{ij , t}^{line} \geq {u}_{ij , t}^{d} + {u}_{ij , t}^{p} - 1 ∀ ij ∈ {ϕ}^{L} , ∀ t ∈ {ϕ}^{T} \qquad ( 17 )$$

if the line is damaged, it cannot be disconnected actively; if the line is disconnected actively, it is unnecessary to consider the line damage condition, that is, u_{ij,t}^{d} and u_{ij,t}^{p} cannot both be 0 at the same time;

$$0 \leq {P}_{j , c , t}^{load} \leq {P}_{j , 0}^{load} ∀ t ∈ {ϕ}^{T} , ∀ j ∈ {ϕ}^{N} \qquad ( 18 )$$

$$0 \leq {Q}_{j , c , t}^{load} \leq {Q}_{j , 0}^{load} ∀ t ∈ {ϕ}^{T} , ∀ j ∈ {ϕ}^{N} \qquad ( 19 )$$

equations (18) and (19) represent load shedding constraints.

In an embodiment of the disclosure, considering the security constraints before, during, and after the disaster, includes:
after the disaster, considering the resources needed repaired and generating set recovery model constraints:

$${l}_{ij , t}^{r e} \leq 1 - {u}_{ij , t}^{d} ∀ ij ∈ {ϕ}^{L} , ∀ t ∈ {ϕ}^{T} \qquad ( 20 )$$

$${\sum }_{t ∈ {ϕ}^{T}} {l}_{ij , t}^{r e} \leq 1 ∀ ij ∈ {ϕ}^{L} \qquad ( 21 )$$

where l_{ij,t}^{re} indicates whether the line ij starts to be repaired at the time t, and if the line ij starts to be repaired at the time t, l_{ij,t}^{re}=1, otherwise, l_{ij,t}^{re}=0;

$${u}_{ij , t}^{d} = {u}_{ij , t}^{*} + {\sum }_{t = 1}^{t - Δ {T}_{ij}^{re}} {l}_{ij , t}^{re} ∀ ij ∈ {ϕ}^{L} , ∀ t ∈ {ϕ}^{T} \qquad ( 22 )$$

where ΔTᵢⱼ^{re} represents a time required to repair the line; after the damaged line has been repaired for ΔTᵢⱼ^{re}, u_{ij,t}^{d} changes from 0 to 1, and u_{ij,t}* indicates whether the line has received a disaster management arrangement provided by a disaster prediction scenario; if the line is damaged at a time t1, u_{ij,t}* ∀t≥t₁;

$${b}_{ij , t}^{re} = {\sum }_{z = t - {T}_{ij}^{re}}^{t} {l}_{ij , z}^{re} ∀ ij ∈ {ϕ}^{L} , ∀ t ∈ {ϕ}^{T} \qquad ( 23 )$$

$${\sum }_{ij ∈ {ϕ}^{L}} {b}_{ij , t}^{re} \leq H ∀ t ∈ {ϕ}^{T} \qquad ( 23 )$$

where H represents the resources needed repaired.

Further, in an embodiment of the disclosure, deducing the mathematical representation of dynamic resilience region, includes:
for a certain disaster scenario, determining a variable 0-1 in the optimized urban power system three-stage model. The constraint conditions of the three-stage model can be written in a compact form as shown in equation (24);

$$A θ + B x \leq c \qquad ( 24 )$$

where A and B are coefficients of θ and x, and c represents a constant in the model; the dynamic resilience region is described as that when key parameters are within the dynamic resilience region, there is always a corresponding x in the power system, and if the key parameters are outside the dynamic resilience region, there is no x that makes equation (24) valid; the dynamic resilience region is represented by Φ_{θ}^{DRR}.

$${Φ}_{θ}^{DRR} = \{ θ \vert ∃ x : A θ \leq c - B x \} \qquad ( 25 )$$

Therefore, it is possible to determine whether a given θ is within the dynamic resilience region by determining whether the corresponding x exists:

$$H ( x ) = \{ x \vert A θ \leq c - Bx \} \qquad ( 26 )$$

in the equation, H is a set composed of x, and the physical meaning of equation (26) is that the scheduling strategy x for the urban power grid that satisfies the key parameter θ;

based on the idea of robust optimization, the positive slack variables are used to represent whether all the θ in the current set are within the dynamic resilience region. Its physical meaning is: whether the farthest point in the current optimization space Φ is within the dynamic resilience region, and if R(θ)=0, it indicates that the current optimization space is in the dynamic resilience region, otherwise, it indicates that θ is outside the dynamic resilience region, that is, the current optimization space is larger than the dynamic resilience region;

$$\begin{matrix}R ( θ ) = {max}_{θ ∈ Φ} {min}_{{r}^{+} \geq 0 , {r}^{-} \geq 0 , x} {1}^{T} {r}^{+} + {1}^{T} {r}^{-} \\ s . t . Bx + {Ir}^{+} - {Ir}^{-} \leq c - A θ\end{matrix} \qquad ( 27 )$$

In the equation, R(θ) is used to represent whether all the θ in the current set Φ are within the dynamic resilience region, that is, R(θ)=0 and H are equivalent to non-empty sets, 1 and I are set vectors of corresponding dimensions, and r⁺ and r⁻ are positive slack variables;
since the two-layer optimization problem shown in equation (27) is difficult to be solved by existing commercial solvers, based on the KKT condition and theorem of strong coexistence, the two-layer optimization problem is deduced as an MPLP problem:

$$\begin{matrix}R ( θ ) = {max}_{θ , d} {d}^{T} ( c - A θ ) \\ s . t . H θ \leq h , - 1 \leq d \leq 0 , {B}^{T} d = 0\end{matrix} \qquad ( 28 )$$

where d is a dual multiplier of inner-layer optimization problem in equation (27), and equation (28) can be written as equation (29) because there is no coupling relationship between d and θ:

$$\begin{matrix}R ( θ ) = {max}_{d} ( {d}^{T} c + {max}_{θ} ( - {d}^{T} A θ ) ) \\ s . t . H θ \leq h , - 1 \leq d \leq 0 , {B}^{T} d = 0\end{matrix} \qquad ( 29 )$$

according to the theorem of strong coexistence, −d^{T}Aθ is converted into h^{T}μ, and KKT condition is introduced to ensure optimality:

$$\begin{matrix}R ( θ ) = {max}_{d , μ , θ} ( {d}^{T} c + {h}^{T} μ ) \\ s . t . - 1 \leq d \leq 0 , {B}^{T} d = 0 , {μ}^{T} ( h - H θ ) = 0 , {A}^{T} d + {H}^{T} μ = 0\end{matrix} \qquad ( 30 )$$

since the KKT condition introduce nonlinear terms, the nonlinear terms are linearized by the big M method:

$$\begin{matrix}R ( θ ) = {max}_{d , μ , θ} ( {d}^{T} c + {h}^{T} μ ) \\ s . t . - 1 \leq d \leq 0 , {B}^{T} d = 0 , {μ}^{T} ( h - H θ ) = 0 , M ω \leq ( h - H θ ) \leq 0 , - M ( 1 - ω ) \leq μ \leq 0\end{matrix} \qquad ( 31 )$$

where μ is a dual multiplier of the inner-layer optimization problem in equation (29), and equation (31) is the MILP problem that can be solved by commercial solvers.

Further, in an embodiment of the disclosure, solving the dynamic resilience region based on the resilience cut line, includes:

when θ=θ₀, if θ₀ is in the dynamic resilience region, it shall satisfies equation (32):

$${d}^{* T} c - {d}^{* T} A {θ}_{0} \leq 0 \qquad ( 33 )$$

in the equation, d* is the optimal solution of equation (31), and d* is a vertex of dual space −1≤d≤0, B^{T}d=0, and thus the dynamic resilience region can be described as (33):

$${Φ}_{θ}^{DRR} = \{ θ \vert {d}^{* T} c \leq {d}^{* T} A θ , {d}^{*} ∈ D \} \qquad ( 34 )$$

in the equation, D is a set of vertices of the dual space, and if θ is outside the dynamic resilience region, it shall satisfies the equation (34):

$${d}^{* T} c > {d}^{* T} A θ , θ ∈ {Φ}_{θ}^{DRR} \qquad ( 35 )$$

therefore, equation (36) defines a hyper-plane that separates the dynamic resilience region and the non-dynamic resilience region, which can be defined as a resilience cut line:

$${d}^{* T} c = {d}^{* T} A θ \qquad ( 36 )$$

the solution process of dynamic resilience region is as follows: firstly, defining a large enough optimization space Φ; solving equation (31), if R(θ)=0, it indicates that the current optimization space is an accurate dynamic resilience region, if R(θ) is not 0, it indicates that the non-dynamic resilience region in the current optimization space still needs to be removed; and calculating equation (36) to obtain a resilience cut line, and add the constraint d*^{T}Aθ≤d*^{T}c corresponding to the cut plane to the Φ to obtain an updated optimization space until R(θ)=0.

Further, in an embodiment of the disclosure, based on the urban power system three-stage model, using the shortest distance from the current operating point to the boundary of the dynamic resilience region to represent the dynamic safety margin of the urban power system under the current disaster prediction scenario, includes:
introducing a positive slack variable to quantify and represent the dynamic safety margin, as shown in equation (37):

$$\begin{matrix}{S}_{t} = {min}_{{s}^{+} \geq 0 , {s}^{-} \geq 0} {1}^{T} {s}^{+} + {1}^{T} {s}^{-} \\ s . t . {H}_{t} {θ}_{0} + {Is}^{+} - {Is}^{-} \geq {h}_{t} , ∀ t ∈ {ϕ}^{T}\end{matrix} \qquad ( 37 )$$

the physical meaning of equation (37) is: the minimum change required in the constraints to push the important load operating points in the current dynamic resilience region beyond the safety boundary.

In order to achieve the above objects, a second aspect of embodiments of the disclosure provides a fast calculation device for dynamic resilience region of urban power system. The device includes:
a constructing module, configured to construct an urban power system three-stage model applicable for multiple types of public safety events by considering security constraints before, during, and after a disaster, to minimize a three-stage operation cost and a load shedding amount of an urban power grid;
a solving module, configured to, based on the urban power system three-stage model, define a boundary between a resilience region and a non-resilience region as a resilience cut line, and remove the non-resilience region from the outside to quickly obtain the dynamic resilience region; and
a predicting module, configured to, based on the urban power system three-stage model, use the shortest distance from a current operating point to the boundary of the dynamic resilience region to represent a dynamic safety margin of the urban power system under a current disaster prediction scenario.

According to the fast calculation method for dynamic resilience region of the urban power system proposed by the embodiments of the disclosure, a three-stage resilience model of urban power system is constructed, to minimize the operating cost and load shedding value of urban power system, and cover the whole life cycle of extreme scenes before, during and after a disaster. Moreover, it proposed an urban power system resilience assessment system based on the dynamic resilience region for the first time. Unlike traditional single resilience indicator, the dynamic resilience region reflects the influence of multi-dimensional security constraints of urban power system and reflects the coupling mechanism of multi-dimensional resilience indicators. It then provides a diagnosis model for determining whether the current optimization space is an accurate dynamic resilience region and a fast resolution algorithm of dynamic resilience region. Based on the resilience cut line, the non-dynamic resilience region of the current optimization space is continuously removed from the outside until the convergence requirements are met. Finally, it also brought the concept of dynamic safety margin, and introduced the positive slack variable to quantify and represent some distance indicators between the current operating point of important load and the boundary of dynamic resilience region, so as to issue safety warning and make plans for extreme scenarios that exceed the limit of the safety margin, which guide the urban power grid to effectively formulate strategies for predicting disaster scenarios, thereby improving the resilience level of power system.

### BRIEF DESCRIPTION OF THE DRAWINGS

The above and/or additional aspects and advantages of embodiments of the disclosure will become apparent and more readily appreciated from the following descriptions made with reference to the accompanying drawings, in which:

FIG. 1 is a flowchart of a fast calculation method for the dynamic resilience region of an urban power system provided by an embodiment of the present invention.

FIG. 2 is a schematic diagram of a fast calculation device for the dynamic resilience region of an urban power system provided by an embodiment of the present invention.

### DETAILED DESCRIPTION

The embodiments of the disclosure are described in detail below, and examples of the embodiments are shown in the accompanying drawings, in which the same or similar numbers indicate the same or similar components or components having the same or similar functions. The embodiments described below by reference to the accompanying drawings are exemplary and are intended to be used to explain the disclosure and are not to be construed as limiting the disclosure.

The fast calculation method for the dynamic resilience region of an urban power system according to the embodiment of the disclosure will be described with reference to the attached drawings.

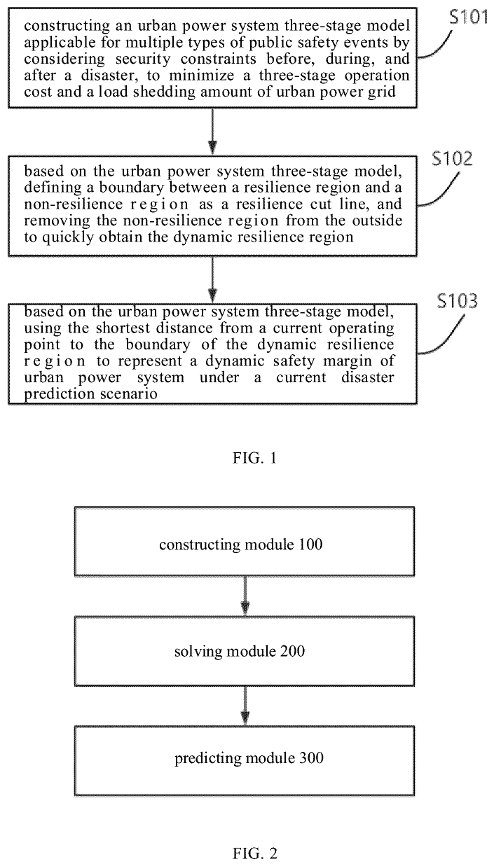

FIG. 1 is a flowchart of a fast calculation method for the dynamic resilience region of an urban power system provided by an embodiment of the disclosure.

As illustrated in FIG. 1, the method includes the following steps.

At step S101, taking into account security constraints before, during, and after a disaster, an urban power system three-stage model applicable for multiple types of public safety events is constructed to minimize a three-stage operation cost and a load shedding amount of an urban power grid.

At step S102, a boundary between a resilience region and a non-resilience region is defined as a resilience cut line based on the urban power system three-stage model, and remove the non-resilience region from the outside to quickly obtain the dynamic resilience region.

At step S103, based on the urban power system three-stage model, a dynamic safety margin of the urban power system under a current disaster prediction scenario is represented by the shortest distance from a current operating point to the boundary of the dynamic resilience region.

Further, in an embodiment of the disclosure, constructing the urban power system three-stage model applicable for multiple types of public safety events by considering the security constraints before, during, and after a disaster, includes:
minimizing an operating cost and a load shedding value of the urban power system three-stage model:

$$min {\sum }_{t} ( {\sum }_{g} {α}_{g} {P}_{g , t}^{2} + {β}_{g} {P}_{g , t} + {γ}_{g} {v}_{g , t} + {\sum }_{j} {c}_{j} {P}_{j , c , t}^{load} ) \qquad ( 1 )$$

where α_{g}, β_{g} and γ_{g} represent the cost coefficients for generating set g, respectively, cⱼ represents a cost coefficient for loss-of-load of load j, P_{g,t} represents an active output of the generating set g at a time t, P_{j,c,t}^{load} represents a load shedding amount loaded by node j at the time t, v_{g,t} represents an on/off state of the generating set g at the time t, and if v_{g,t}=0, it indicates that the generating set is off, otherwise, it indicates that the generating set is on. The active output of a generating set refers to the actual useful power generated by the generating set per unit time.

In an embodiment of the disclosure, considering the security constraints before, during, and after a disaster, includes:
before the disaster, considering power flow constraints, node balance and generating set output constraints, wherein linearizing power flow constraints are as follows:

$$\begin{matrix}{P}_{ij , t} = {G}_{ij} ( {U}_{i , t} - {U}_{j , t} ) / 2 - {B}_{ij} ( {θ}_{i , t} - {θ}_{j , t} ) & ∀ t ∈ {ϕ}^{T} , ∀ i ∈ {ϕ}^{N}\end{matrix} \qquad ( 2 )$$

$$\begin{matrix}{Q}_{ij , t} = - {G}_{ij} ( {θ}_{i , t} - {θ}_{j , t} ) - {B}_{ij} ( {U}_{i , t} - {U}_{j , t} ) / 2 & ∀ t ∈ {ϕ}^{T} , ∀ i ∈ {ϕ}^{N}\end{matrix} \qquad ( 3 )$$

where U_{i,t} and U_{j,t} represent voltage magnitudes at nodes i and j at the time t respectively, θ_{i,t} and θ_{j,t} represent voltage phase angles at the nodes i and j at the time t, Gᵢⱼ and Bᵢⱼ represent conductance and susceptance values between the nodes i and j, respectively, Ø^{N} represents a set of power system nodes, and Ø^{T} represents a set of time nodes, equations (2) and (3) describe calculation methods of active and reactive power flows of a line ij, respectively;
voltage and phase angle constraints are shown in equations (4) and (5):

$$\begin{matrix}{U}_{min} \leq {U}_{i , t} \leq {U}_{max} & ∀ t ∈ {ϕ}^{T} , ∀ i ∈ {ϕ}^{N}\end{matrix} \qquad ( 4 )$$

$$\begin{matrix}{θ}_{min} \leq {U}_{i , t} \leq {θ}_{max} & ∀ t ∈ {ϕ}^{T} , ∀ i ∈ {ϕ}^{N}\end{matrix} \qquad ( 5 )$$

where Uₘᵢₙ and Uₘₐₓ represent lower and upper limits of voltage amplitude, respectively, and θₘᵢₙ and θₘₐₓ represent upper and lower limits of voltage phase angle, respectively;
power system power flow constraints are shown in equations (6)-(9):

$$\begin{matrix}- {u}_{ij , t}^{line} {F}_{ij , max} \leq {P}_{ij , t} \leq {u}_{ij , t}^{line} {F}_{ij , max} & ∀ t ∈ {ϕ}^{T} , ∀ ij ∈ {ϕ}^{L}\end{matrix} \qquad ( 6 )$$

$$\begin{matrix}- {u}_{ij , t}^{line} {F}_{ij , max} \leq {Q}_{ij , t} \leq {u}_{ij , t}^{line} {F}_{ij , max} & ∀ t ∈ {ϕ}^{T} , ∀ ij ∈ {ϕ}^{L}\end{matrix} \qquad ( 7 )$$

$$- \sqrt{2} \begin{matrix}{u}_{ij , t}^{line} {F}_{ij , max} \leq {P}_{ij , t} + {Q}_{ij , t} \leq \sqrt{2} {u}_{ij , t}^{line} {F}_{ij , max} & ∀ t ∈ {ϕ}^{T} , ∀ ij ∈ {ϕ}^{L}\end{matrix} \qquad ( 8 )$$

$$- \sqrt{2} \begin{matrix}{u}_{ij , t}^{line} {F}_{ij , max} \leq {P}_{ij , t} - {Q}_{ij , t} \leq \sqrt{2} {u}_{ij , t}^{line} {F}_{ij , max} & ∀ t ∈ {ϕ}^{T} , ∀ ij ∈ {ϕ}^{L}\end{matrix} \qquad ( 9 )$$

where F_{ij,max} represents an upper limit of power flow of the line ij; u_{ij,t}^{line} represents a line status, if u_{ij,t}^{line}=0, it indicates that the line is disconnected, if u_{ij,t}^{line}=1, it indicates that the line status is normal, and Ø^{L} represents a set of lines;
node power balance constraints are shown in equations (10)-(11):

$${\sum }_{j ∈ {ϕ}^{N}} {P}_{ji , t} - {\sum }_{j ∈ {ϕ}^{N}} {P}_{ij , t} + {\sum }_{g ∈ {ϕ}^{G} ( i )} {P}_{g , t} = {P}_{i , 0}^{load} - {P}_{i , c , t}^{l o a d} ∀ t ∈ {ϕ}^{T} , ∀ i ∈ {ϕ}^{N} \qquad ( 10 )$$

$${\sum }_{j ∈ {ϕ}^{N}} {Q}_{ji , t} - {\sum }_{j ∈ {ϕ}^{N}} {Q}_{ij , t} + {\sum }_{g ∈ {ϕ}^{G} ( i )} {Q}_{g , t} = {Q}_{i , 0}^{load} - {Q}_{i , c , t}^{load} ∀ t ∈ {ϕ}^{T} , ∀ i ∈ {ϕ}^{N} \qquad ( 11 )$$

where P_{j,0}^{load} and Q_{j,0}^{load} represent active and reactive power demands of the node j, respectively, P_{g,t} and Q_{g,t} represent active and reactive outputs of the generator g at the time t, respectively, and Ø^{N} represents a set of generating sets, P_{j,c,t}^{load} load and Q_{j,c,t}^{load} represent load shedding amounts of node j at the time t, which is 0 before the disaster;
generating set output constraint and load shedding constraint are shown in equations (12)-(14):

$${v}_{g , t} {P}_{g , min} \leq {P}_{g , t} \leq {v}_{g , t} {P}_{g , max} ∀ t ∈ [ 1 , {t}_{e n d} ] , ∀ g ∈ {ϕ}^{G} \qquad ( 12 )$$

$${ν}_{g , t} {Q}_{g , min} \leq {Q}_{g , t} \leq {ν}_{g , t} {Q}_{g , max} ∀ t ∈ {ϕ}^{T} , ∀ g ∈ {ϕ}^{G} \qquad ( 13 )$$

$${R}_{g} \leq {P}_{g , t} - {P}_{g , t - 1} \leq {R}_{g} ∀ t ∈ {ϕ}^{T} , ∀ g ∈ {ϕ}^{G} \qquad ( 14 )$$

where v_{i,t} represents an operating state of a generating sets i at the time t, and if v_{i,t}=1, it indicates the generating set is operating normally, otherwise, the generating set is shut down; P_{g,min} and P_{g,max} represent the minimum and maximum outputs of the generating set respectively; equations (12) and (13) represent the generating set output constraints, and equation (14) represents a generating set climbing constraint.

In an embodiment of the disclosure, considering the security constraints before, during, and after a disaster, includes:
under the influence of the disaster, introducing a binary variable u_{ij,t}^{d} to represent a line damage condition; if u_{ij,t}^{d}=0, it indicates that the line is damaged and disconnected due to the disaster; and introducing a binary variable u_{ij,t}^{p} to represent an active disconnection of the line; if u_{ij,t}^{p}+=0, it indicates that the line ij is actively disconnected to avoid fault propagation, in which logic constraints of u_{ij,t}^{line}, u_{ij,t}^{d} and u_{ij,t}^{p} are as follows:

$${u}_{ij , t}^{l i n e} \leq {u}_{ij , t}^{p} ∀ ij ∈ {ϕ}^{L} , ∀ t ∈ {ϕ}^{T} \qquad ( 15 )$$

$${u}_{ij , t}^{l i n e} \leq {u}_{ij , t}^{d} ∀ ij ∈ {ϕ}^{L} , ∀ t ∈ {ϕ}^{T} \qquad ( 16 )$$

$${u}_{ij , t}^{l i n e} \geq {u}_{ij , t}^{d} + {u}_{ij , t}^{p} - 1 ∀ ij ∈ {ϕ}^{L} , ∀ t ∈ {ϕ}^{T} \qquad ( 17 )$$

if the line is damaged, it cannot be disconnected actively; if the line is disconnected actively, it is unnecessary to consider the line damage condition, that is, u_{ij,t}^{d} and u_{ij,t}^{p} cannot both be 0 at the same time;

$$0 \leq {P}_{j , c , t}^{l o a d} \leq {P}_{j , 0}^{l o a d} ∀ t ∈ {ϕ}^{T} , ∀ j ∈ {ϕ}^{N} \qquad ( 18 )$$

$$0 \leq {Q}_{j , c , t}^{l o a d} \leq {Q}_{j , 0}^{load} ∀ t ∈ {ϕ}^{T} , ∀ j ∈ {ϕ}^{N} \qquad ( 19 )$$

equations (18) and (19) represent load shedding constraints.

In an embodiment of the disclosure, considering the security constraints before, during, and after a disaster, includes:
after the disaster, considering the resources needed repaired and generating set recovery model constraints:

$${l}_{ij , t}^{r e} \leq 1 - {u}_{ij , t}^{d} ∀ ij ∈ {ϕ}^{L} , ∀ t ∈ {ϕ}^{T} \qquad ( 20 )$$

$${\sum }_{t ∈ {ϕ}^{T}} {l}_{ij , t}^{r e} \leq 1 ∀ ij ∈ {ϕ}^{L} \qquad ( 21 )$$

where l_{ij,t}^{re} indicates whether the line ij starts to be repaired at the time t, and if the line ij starts to be repaired at the time t, l_{ij,t}^{re}=1, otherwise, l_{ij,t}^{re}=0;

$${u}_{ij , t}^{d} = {u}_{ij , t}^{*} + {\sum }_{t = 1}^{t - Δ {T}_{ij}^{re}} {l}_{ij , t}^{r e} ∀ ij ∈ {ϕ}^{L} , ∀ t ∈ {ϕ}^{T} \qquad ( 22 )$$

where ΔTᵢⱼ^{re} represents a time required to repair the line; after the damaged line has been repaired for ΔTᵢⱼ^{re}, u_{ij,t}^{d} changes from 0 to 1, and u_{ij,t}* indicates whether the line has received a disaster management arrangement provided by a disaster prediction scenario; if the line is damaged at a time t1, u_{ij,t}*∀t≥t₁;

$${b}_{ij , t}^{r e} = {\sum }_{z = t - Δ {T}_{ij}^{re}}^{t} {l}_{ij , z}^{r e} ∀ ij ∈ {ϕ}^{L} , ∀ t ∈ {ϕ}^{T} \qquad ( 23 )$$

$${\sum }_{ij ∈ {ϕ}^{L}} {b}_{ij , t}^{r e} \leq H ∀ t ∈ {ϕ}^{T} \qquad ( 23 )$$

where H represents resources needed repaired.

In an embodiment of the disclosure, deducing the mathematical representation of dynamic resilience region, includes:
for a certain disaster scenario, determining a variable 0-1 in the optimized urban power system three-stage model. The constraint conditions of the three-stage model can be written in a compact form as shown in equation (24);

$$A θ + B x \leq c \qquad ( 24 )$$

where A and B are coefficients of θ and x, and c represents a constant in the model; the dynamic resilience region is described as that when key parameters are within the dynamic resilience region, there is always a corresponding x in the power system, and if the key parameters are outside the dynamic resilience region, there is no x that makes equation (24) valid; the dynamic resilience region is represented by Φ_{θ}^{DRR}:

$${Φ}_{θ}^{DRR} = \{ θ \vert ∃ x : A θ \leq c - B x \} \qquad ( 25 )$$

Therefore, it is possible to determine whether a given θ is within the dynamic resilience region by determining whether the corresponding x exists:

$$H ( x ) = \{ x \vert A θ \leq c - B x \} \qquad ( 26 )$$

in the equation, H is a set composed of x, and the physical meaning of equation (26) is that the scheduling strategy x for the urban power grid that satisfies the key parameter θ;
based on the idea of robust optimization, the positive slack variables are used to represent whether all the θ in the current set are within the dynamic resilience region, its physical meaning is whether the farthest point in the current optimization space Φ is within the dynamic resilience region, and if R(θ)=0, it indicates that the current optimization space is in the dynamic resilience region, otherwise, it indicates that θ is outside the dynamic resilience region, that is, the current optimization space is larger than the dynamic resilience region;

$$R ( θ ) = {max}_{θ ∈ Φ} {min}_{{r}^{+} \geq 0 , {r}^{-} \geq 0 , x} {1}^{T} {r}^{+} + {1}^{T} {r}^{-} s . t . Bx + {Ir}^{+} - {Ir}^{-} \leq c - A θ \qquad ( 27 )$$

in the equation, R(θ) is used to represent whether all the θ in the current set Φ are within the dynamic resilience region, that is, R(θ)=0 and H are equivalent to non-empty sets, 1 and I are set vectors of corresponding dimensions, and r⁺ and r⁻ are positive slack variables;
since the two-layer optimization problem shown in equation (27) is difficult to be solved by existing commercial solvers, based on the KKT condition and theorem of strong coexistence, the two-layer optimization problem is deduced as an MPLP problem:

$$R ( θ ) = {max}_{θ , d} {d}^{T} ( c - A θ ) s . t . H θ \leq h , - 1 \leq d \leq 0 , {B}^{T} d = 0 \qquad ( 28 )$$

where d is a dual multiplier of inner-layer optimization problem in equation (27), and equation (28) can be written as equation (29) because there is no coupling relationship between d and θ:

$$R ( θ ) = {max}_{d} ( {d}^{T} c + {max}_{θ} ( - {d}^{T} A θ ) ) s . t . H θ \leq h , - 1 \leq d \leq 0 , {B}^{T} d = 0 \qquad ( 29 )$$

according to the theorem of strong coexistence, −d^{T}Aθ is converted into h^{T}μ, and KKT condition is introduced to ensure optimality:

$$R ( θ ) = {max}_{d , μ , θ} ( {d}^{T} c + {h}^{T} μ ) s . t . - 1 \leq d \leq 0 , {B}^{T} d = 0 , {μ}^{T} ( h - H θ ) = 0 , {A}^{T} d + {H}^{T} μ = 0 \qquad ( 30 )$$

since the KKT condition introduce nonlinear terms, the nonlinear terms are linearized by the big M method:

$$R ( θ ) = {max}_{d , μ , θ} ( {d}^{T} c + {h}^{T} μ ) \\ s . t . - 1 \leq d \leq 0 , {B}^{T} d = 0 , {A}^{T} d + {H}^{T} μ = 0 , - M ω \leq ( h - H θ ) \leq 0 , - M ( 1 - ω ) \leq μ \leq 0 \qquad ( 31 )$$

where μ is a dual multiplier of the inner-layer optimization problem in equation (29), and equation (31) is the MILP problem that can be solved by commercial solvers.

In an embodiment of the disclosure, solving the dynamic resilience region based on the resilience cut line, includes:
when θ=θ₀, if θ₀ is in the dynamic resilience region, it shall satisfies equation (32):

$${d}^{* T} c - {d}^{* T} A {θ}_{0} \leq 0 \qquad ( 33 )$$

in the equation, d* is the optimal solution of equation (31), and d* is a vertex of dual space −1≤d≤0, B^{T}d=0, and thus the dynamic resilience region can be described as (33):

$${Φ}_{θ}^{DRR} = \{ θ \vert {d}^{* T} c \leq {d}^{* T} A θ , {d}^{*} ∈ D \} \qquad ( 34 )$$

in the equation, D is a set of vertices of the dual space, and if θ is outside the dynamic resilience region, it shall satisfies the equation (34):

$${d}^{* T} c > {d}^{* T} A θ , θ ∉ {Φ}_{θ}^{DRR} \qquad ( 35 )$$

equation (36) defines a hyper-plane that separates the dynamic resilience region and the non-dynamic resilience region, which can be defined as a resilience cut line:

$${d}^{* T} c = {d}^{* T} A θ \qquad ( 36 )$$

the solution process of dynamic resilience region is as follows: firstly, defining a large enough optimization space Φ; solving equation (31), if R(θ)=0, it indicates that the current optimization space is an accurate dynamic resilience region, otherwise, it indicates that the non-dynamic resilience region in the current optimization space still needs to be removed; and calculating equation (36) to obtain a resilience cut line, and add the constraint d*^{T}Aθ≤d*^{T}c corresponding to the cut plane to the Φ to obtain an updated optimization space until R(θ)=0.

Further, in an embodiment of the disclosure, based on the urban power system three-stage model, using the shortest distance from the current operating point to the boundary of the dynamic resilience region to represent the dynamic safety margin of urban power system under the current disaster prediction scenario, includes:
introducing a positive slack variable to quantify and represent the dynamic safety margin, as shown in equation (37):

$$\begin{matrix}{S}_{t} = {min}_{{s}^{+} \geq 0 , {s}^{-} > 0} {1}^{T} {s}^{+} + {1}^{T} {s}^{-} \\ s . t . {H}_{t} {θ}_{0} + I {s}^{+} - {Is}^{-} \geq {h}_{t} , ∀ t ∈ {ϕ}^{T}\end{matrix} \qquad ( 37 )$$

the physical meaning of equation (37) is: the minimum change required in the constraints to push the important load operating points in the current dynamic resilience region to move beyond a certain safety boundary of the current dynamic resilience region. In this application, the shortest distance from the operating point to each boundary of the current dynamic resilience region is defined as the safety margin. The operating point of a load or the node where the load is located characterizes the state of certain features of the load or node. For example, it can include the state of the active power output of the generator set at the node, the state of the load-shedding quantity at the node, the state of power flow at the node, etc. A node can refer to a substation in the power grid, for example.

Therefore, for a certain disaster prediction scenario, the dynamic safety margin under this scenario is solved, and the pre-plan and emergency scheduling strategy are formulated for extreme scenarios that may exceed the limit of the safety margin, which significantly improves the resilience level of the power grid. Compare to traditional resilience indicator, the dynamic safety margin provided by the disclosure considers the influence of multiple safety constraints and embodies the coupling mechanism of multiple indicators.

Efficient representation based on safety margin. On the one hand, grid scheduling can focus on disaster scenarios with low or zero safety margins before a disaster strikes and formulate targeted prevention strategies. For example, it is possible to analyze the dynamic resilience region of the nodes where the important loads are located under different disaster scenarios and quantify the dynamic safety margins of the important loads under each scenario before the disaster, and then filter the scenarios that may cause extreme impacts on the power grid, i.e., scenarios that result in low or even zero safety margins for the important loads. Grid scheduling can purposefully carry out preventive measures for such scenarios, e.g., reinforcement of lines that may be damaged under such scenarios, deployment of mobile energy storage of the urban power system for critical loads in scenarios where the safety margin of the nodes where the critical loads are located is low before the disaster. On the other hand, it can provide grid scheduling with clear prevention and emergency scheduling planning when a disaster strikes, For example, by adjusting the active output of generating sets, the active output of distributed resources, and load shedding amount of the nodes of the urban power system, the location of the operating point of the key nodes is changed so that the key nodes of the power system (e.g., nodes with important loads, such as hospitals) are operated in the position with the largest safety margin to ensure that the key nodes are not overloaded, so as to safeguard the important loads (e.g., hospitals) in the event of a disaster.

First, the dynamic resilience region of key nodes under disaster prediction scenarios is solved, and the safety margin of the operating point node in the resilience region is maximized in the objective function to guide the generation of emergency scheduling strategies for large urban power grids. This is expressed in the following equation:

$$\begin{matrix}f = {\sum }_{t} {max}_{y} ( {min}_{{s}^{+} \geq 0 , {s}^{-} > 0} ( {e}^{T} {s}^{+} + {e}^{T} {s}^{-} ) - {R}_{t} {v}_{l} {P}_{ls , t} ) \\ \begin{matrix}s . t . D θ + {Is}^{+} - {Is}^{-} \geq d & : u \\ {A}_{1} y \leq {b}_{1} & : v \\ {A}_{2} y + {B}_{2} θ = {b}_{2} & : λ \\ D θ \leq d & : k\end{matrix}\end{matrix} \qquad ( 38 )$$

wherein: Rₜ represents the load-shedding penalty item at time t; vₗrepresents the value coefficient of load l; P_{ls,t}represents the load-shedding amount of load l at time t; constraint A₁y≤b₁is a constraint independent of the projection variable (actual operating power of important loads), such as constraints on set operation, operation constraints of distributed resources such as energy storage, and network power flow constraints; constraint A₂y+B₂θ=b₂ is a parameter related to both the projection variable and non-projection variables, i.e., the balance constraint of the important load nodes and the operation constraint of the important load (P_{L}=P_{LO}−P_{LS}), which are all equality constraints; Dθ≤d is a constraint in the resilience region. μ, v,λ, and k are the corresponding dual multipliers of the constraints.

According to the fast calculation method for dynamic resilience region of urban power system proposed by the embodiments of the disclosure, a three-stage resilience model of urban power system is constructed, to minimize the operating cost and load shedding value of urban power system, and cover the whole life cycle of extreme scenes before, during and after disaster. Moreover, it proposed an urban power system resilience evaluation system based on dynamic resilience region at the first time. Different from traditional single resilience indicator, the dynamic resilience region reflects the influence of multi-dimensional security constraints of urban power system and reflects the coupling mechanism of multi-dimensional resilience indicators. It then provides a diagnosis model for determining whether the power flow optimization space is an accurate dynamic resilience region and a fast resolution algorithm of dynamic resilience region. Based on the resilience cut line, the non-dynamic resilience region of the current optimization space is continuously removed from the outside until the convergence requirements are met. Finally, it also brought the concept of dynamic safety margin, and introduced the positive slack variable to quantify and represent some distance indicators between the current operating point of important load and the boundary of dynamic resilience region, so as to issue safety warning and make plans for extreme scenarios that exceed the limit of the safety margin, which guide the urban power grid to effectively formulate strategies for predicting disaster scenarios, thereby improving the resilience level of power system.

In order to realize the above embodiments, the disclosure provides a fast calculation device for dynamic resilience region of urban power system.

FIG. 2 is a schematic diagram of a fast calculation device for dynamic resilience region of urban power system provided by an embodiment of the disclosure.

As illustrated in FIG. 2, the device includes:
a constructing module 100, configured to construct an urban power system three-stage model applicable for multiple types of public safety events by considering security constraints before, during, and after a disaster, to minimize a three-stage operation cost and a load shedding amount of the urban power grid;
a solving module 200, configured to, based on the urban power system three-stage model, define a boundary between a resilience region and a non-resilience region as a resilience cut line, and remove the non-resilience region from the outside to quickly obtain the dynamic resilience region; and
a predicting module 300, configured to, based on the urban power system three-stage model, use the shortest distance from a current operating point to the boundary of the dynamic resilience region to represent a dynamic safety margin of urban power system under a current disaster prediction scenario.

Reference throughout this specification to “an embodiment,” “some embodiments,” “an example,” “a specific example,” or “some examples,” means that specific features, structures, materials or characteristics described in combination with the embodiment or example is included in at least one embodiment or example of the disclosure. In this specification, the schematic expressions of the above terms are not necessarily for the same embodiment or example. Moreover, the specific features, structures, materials or characteristics described may be combined in any one or more embodiments or examples in a suitable manner. In addition, those skilled in the art can use and combine different embodiments or examples and features of different embodiments or examples described in this specification without contradicting each other.

In addition, the terms “first” and “second” are only used for description, and cannot be understood as indicating or implying relative importance or implicitly indicating the number of indicated technical features. Therefore, the feature defined with the term “first” or “second” can explicitly or implicitly include at least one of the feature. In the description of the disclosure, “multiple” means at least two, such as two, three, etc., unless otherwise specifically defined.

Although the embodiments of the disclosure have been shown and described above, it can be understood that the above embodiments are exemplary and cannot be understood as limitations of the disclosure, and those skilled in the art can make changes, modifications, substitutions and variations to the above embodiments within the scope of the disclosure.

What is claimed is:

1. A fast calculation method for a dynamic resilience region of an urban power system, comprising:
constructing an urban power system three-stage model applicable for multiple types of public safety events by considering security constraints before, during, and after a disaster, to minimize a three-stage operation cost and a load shedding amount of urban power grid;
based on the urban power system three-stage model, defining a boundary between a resilience region and a non-resilience region as a resilience cut line, and removing the non-resilience region from outside to quickly obtain the dynamic resilience region; and
based on the urban power system three-stage model, using a shortest distance from a current operating point to the boundary of the dynamic resilience region to represent a dynamic safety margin of the urban power system under a current disaster prediction scenario;
wherein formulating strategies of the urban power system based on the safety margin, comprises at least one of:
deploying mobile energy storage of the urban power system for critical loads in scenarios where the safety margin of nodes where the critical loads are located is low before a disaster; or,
adjusting an active output of generating sets of the urban power system, the active output of distributed resources of the urban power system, and the load shedding amount of the nodes of the urban power system so that critical nodes of the urban power system are operated in a position with a highest safety margin to avoid overloads during a disaster.

2. The method of claim 1, wherein constructing the urban power system three-stage model applicable for various types of public safety events by considering the security constraints before, during, and after the disaster, comprises:
minimizing an operating cost and a load shedding value of the urban power system three-stage model:
$$min {\sum }_{t} ( {\sum }_{g} {α}_{g} {P}_{g , t}^{2} + {β}_{g} {P}_{g , t} + {γ}_{g} {v}_{g , t} + {\sum }_{j} {c}_{j} {P}_{j , c , t}^{l o a d} ) \qquad ( 1 )$$
where α_{g}, β_{g} and γ_{g} represent cost coefficients for a generating set g, respectively, cⱼ represents a cost coefficient for loss-of-load of load j, P_{g,t} represents an active output of the generating set g at a time t, P_{j,c,t}^{load} represents a load shedding amount loaded by node j at the time t, v_{g,t} represents an on/off state of the generating set g at the time t, and if v_{g,t}=0, it indicates that the generating set is off, otherwise, it indicates that the generating set is on.

3. The method of claim 1, wherein considering the security constraints before, during, and after the disaster, comprises:
before the disaster, considering power flow constraints, node balance and generating set output constraints, wherein linearizing the power flow constraints are as follows:
$$\begin{matrix}{P}_{ij , t} = {G}_{i j} ( {U}_{i , t} - {U}_{j , t} ) / 2 - {B}_{i j} ( {θ}_{i , t} - {θ}_{j , t} ) & ∀ t ∈ {ϕ}^{T} , ∀ i ∈ {ϕ}^{N}\end{matrix} \qquad ( 2 )$$
$$\begin{matrix}{Q}_{ij , t} = - {G}_{i j} ( {θ}_{i , t} - {θ}_{j , t} ) - {B}_{i j} ( {U}_{i , t} - {U}_{j , t} ) / 2 & ∀ t ∈ {ϕ}^{T} , ∀ i ∈ {ϕ}^{N}\end{matrix} \qquad ( 3 )$$
where U_{i,t} and U_{j,t} represent voltage magnitudes at nodes i and j at a time t respectively, θ_{i,t} and θ_{j,t} represent voltage phase angles at the nodes i and j at the time t, Gᵢⱼ and Bᵢⱼ represent conductance and susceptance values between the nodes i and j, respectively, Ø^{N} represents a set of power system nodes, and Ø^{T} represents a set of time nodes, equations (2) and (3) describe calculation methods of active and reactive power flows of a line ij, respectively;
voltage and phase angle constraints are shown in equations (4) and (5):
$$\begin{matrix}{U}_{min} \leq {U}_{i , t} \leq {U}_{max} & ∀ t ∈ {ϕ}^{T} , ∀ i ∈ {ϕ}^{N}\end{matrix} \qquad ( 4 )$$
$$\begin{matrix}{θ}_{min} \leq {θ}_{i , t} \leq {θ}_{max} & ∀ t ∈ {ϕ}^{T} , ∀ i ∈ {ϕ}^{N}\end{matrix} \qquad ( 5 )$$
where Uₘᵢₙ and Uₘₐₓ represent lower and upper limits of voltage amplitude, respectively, and θₘᵢₙ and θₘₐₓ represent upper and lower limits of voltage phase angle, respectively;
power system power flow constraints are shown in equations (6)-(9):
$$\begin{matrix}- {u}_{ij , t}^{l i n e} {F}_{ij , max} \leq {P}_{ij , t} \leq {u}_{ij , t}^{l i n e} {F}_{ij , max} & ∀ t ∈ {ϕ}^{T} , ∀ ij ∈ {ϕ}^{L}\end{matrix} \qquad ( 6 )$$
$$\begin{matrix}- {u}_{ij , t}^{l i n e} {F}_{ij , max} \leq {Q}_{ij , t} \leq {u}_{ij , t}^{l i n e} {F}_{ij , max} & ∀ t ∈ {ϕ}^{T} , ∀ ij ∈ {ϕ}^{L}\end{matrix} \qquad ( 7 )$$
$$- \begin{matrix}\sqrt{2} {u}_{ij , t}^{l i n e} {F}_{ij , max} \leq {P}_{ij , t} + {Q}_{ij , t} \leq \sqrt{2} {u}_{ij , t}^{l i n e} {F}_{ij , max} & ∀ t ∈ {ϕ}^{T} , ∀ ij ∈ {ϕ}^{L}\end{matrix} \qquad ( 8 )$$
$$- \begin{matrix}\sqrt{2} {u}_{ij , t}^{l i n e} {F}_{ij , max} \leq {P}_{ij , t} - {Q}_{ij , t} \leq \sqrt{2} {u}_{ij , t}^{l i n e} {F}_{ij , max} & ∀ t ∈ {ϕ}^{T} , ∀ ij ∈ {ϕ}^{L}\end{matrix} \qquad ( 9 )$$
where F_{ij,max} represents an upper limit of power flow of the line ij; u_{ij,t}^{line} represents a line status, if u_{ij,t}^{line}=0, it indicates that the line is disconnected, if u_{ij,t}^{line}=1, it indicates that the line status is normal, and Ø^{L} represents a set of lines;
node power balance constraints are shown in equations (10)-(11):
$$\begin{matrix}{\sum }_{j ∈ {ϕ}^{N}} {P}_{ji , t} - {\sum }_{j ∈ {ϕ}^{N}} {P}_{ij , t} + {\sum }_{g ∈ {ϕ}^{G} ( i )} {P}_{g , t} = {P}_{i , 0}^{l o o d} - {P}_{i , c , t}^{l o a d} & ∀ t ∈ {ϕ}^{T} , ∀ i ∈ {ϕ}^{N}\end{matrix} \qquad ( 10 )$$
$$\begin{matrix}{\sum }_{j ∈ {ϕ}^{N}} {Q}_{ji , t} - {\sum }_{j ∈ {ϕ}^{N}} {Q}_{ij , t} + {\sum }_{g ∈ {ϕ}^{G} ( i )} {Q}_{g , t} = {Q}_{i , 0}^{l o o d} - {Q}_{i , c , t}^{l o a d} & ∀ t ∈ {ϕ}^{T} , ∀ i ∈ {ϕ}^{N}\end{matrix} \qquad ( 11 )$$
where P_{j,0}^{load} and Q_{j,0}^{load} represent active and reactive power demands of the node j, respectively, P_{g,t} and Q_{g,t} represent active and reactive outputs of a generator g at the time t, respectively, and Ø^{N} represents a set of generating sets, P_{j,c,t}^{load} and load Q_{j,c,t}^{load} represent a load shedding amount of node j at the time t, which is 0 before the disaster;
generating set output constraint and load shedding constraint are shown in equations (12)-(14):
$$\begin{matrix}{v}_{g , t} {P}_{g , min} \leq {P}_{g , t} \leq {v}_{g , t} {P}_{g , max} & ∀ t ∈ [ 1 , {t}_{e n d} ] , ∀ g ∈ {ϕ}^{G}\end{matrix} \qquad ( 12 )$$
$$\begin{matrix}{ν}_{g , t} {Q}_{g , min} \leq {Q}_{g , t} \leq {ν}_{g , t} {Q}_{g , max} & ∀ t ∈ {ϕ}^{T} , ∀ g ∈ {ϕ}^{G}\end{matrix} \qquad ( 13 )$$
$$\begin{matrix}{R}_{g} \leq {P}_{g , t} - {P}_{g , t - 1} \leq {R}_{g} & ∀ t ∈ {ϕ}^{T} , ∀ g ∈ {ϕ}^{G}\end{matrix} \qquad ( 14 )$$
where v_{i,t} represents an operating state of a generating set i at the time t, and if v_{i,t}=1, it indicates the generating set is operating normally, otherwise, the generating set is shut down; P_{g,min} and P_{g,max} represent minimum and maximum outputs of the generating set respectively; equations (12) and (13) represent the generating set output constraints, and equation (14) represents a generating set climbing constraint.

4. The method of claim 1, wherein considering the security constraints before, during, and after the disaster, comprises:
under the influence of the disaster, introducing a binary variable u_{ij,t}^{d} to represent a line damage condition; if u_{ij,t}^{d}=0, it indicates that the line is damaged and disconnected due to the disaster; and introducing a binary variable u_{ij,t}^{p} to represent an active disconnection of the line; if u_{ij,t}^{p}=0, it indicates that the line ij is actively disconnected to avoid fault propagation, wherein logic constraints of u_{ji,t}^{line}, u_{ij,t}^{d} and u_{ij,t}^{p} are as follows:
$$\begin{matrix}{u}_{ij , t}^{l i n e} \leq {u}_{ij , t}^{p} & ∀ ij ∈ {ϕ}^{L} , ∀ t ∈ {ϕ}^{T}\end{matrix} \qquad ( 15 )$$
$$\begin{matrix}{u}_{ij , t}^{l i n e} \leq {u}_{ij , t}^{d} & ∀ ij ∈ {ϕ}^{L} , ∀ t ∈ {ϕ}^{T}\end{matrix} \qquad ( 16 )$$
$$\begin{matrix}{u}_{ij , t}^{l i n e} \geq {u}_{ij , t}^{d} + {u}_{ij , t}^{p} - 1 & ∀ ij ∈ {ϕ}^{L} , ∀ t ∈ {ϕ}^{T}\end{matrix} \qquad ( 17 )$$
if the line is damaged, it cannot be disconnected actively; if the line is disconnected actively, it is unnecessary to consider the line damage condition, that is, u_{ij,t}^{d} and u_{ij,t}^{p} cannot both be 0 at the same time;
$$\begin{matrix}0 \leq {P}_{j , c , t}^{l o a d} \leq {P}_{j , 0}^{l o a d} & ∀ t ∈ {ϕ}^{T} , ∀ j ∈ {ϕ}^{N}\end{matrix} \qquad ( 18 )$$
$$\begin{matrix}0 \leq {Q}_{j , c , t}^{l o a d} \leq {Q}_{j , 0}^{l o o d} & ∀ t ∈ {ϕ}^{T} , ∀ j ∈ {ϕ}^{N}\end{matrix} \qquad ( 19 )$$
equations (18) and (19) represent load shedding constraints.

5. The method of claim 1, wherein considering the security constraints before, during, and after the disaster, comprises:
after the disaster, considering resources needed to be repaired and generating set recovery model constraints:
$$\begin{matrix}{l}_{ij , t}^{r e} \leq 1 - {u}_{ij , t}^{d} & ∀ ij ∈ {ϕ}^{L} , ∀ t ∈ {ϕ}^{T}\end{matrix} \qquad ( 20 )$$
$$\begin{matrix}{\sum }_{t ∈ {ϕ}^{T}} {l}_{ij , t}^{r e} \leq 1 & ∀ ij ∈ {ϕ}^{L}\end{matrix} \qquad ( 21 )$$
where l_{ij,t}^{re} indicates whether a line ij starts to be repaired at a time t, and if the line ij starts to be repaired at the time t, l_{ij,t}^{re}=1, otherwise, l_{ij,t}^{re}=0;
$${u}_{ij , t}^{d} = {u}_{ij , t}^{*} + {\sum }_{t = 1}^{t - Δ {T}_{ij}^{re}} {l}_{ij , t}^{re} ∀ ij ∈ {ϕ}^{L} , ∀ t ∈ {ϕ}^{T} \qquad ( 22 )$$
where ΔTᵢⱼ^{re} represents a time required to repair the line; after a damaged line has been repaired for ΔTᵢⱼ^{re}, u_{ij,t}^{d} changes from 0 to 1, and u_{ij,t}* indicates whether the line has received a disaster management arrangement provided by a disaster prediction scenario; if the line is damaged at a time t1, uij,t*∀≥t₁;
$${b}_{ij , t}^{re} = {\sum }_{z = t - Δ {T}_{ij}^{re}}^{t} {l}_{ij , z}^{re} ∀ ij ∈ {ϕ}^{L} , ∀ t ∈ {ϕ}^{T} \qquad ( 23 )$$
$${\sum }_{ij ∈ {ϕ}^{L}} {b}_{ij , t}^{r e} \leq H ∀ t ∈ {ϕ}^{T} \qquad ( 23 )$$
where H represents the resources needed to be repaired.

6. The method of claim 1, wherein based on the urban power system three-stage model, defining the boundary between the resilience region and the non-resilience region as the resilience cut line, and removing the non-resilience region from the outside to quickly obtain the dynamic resilience region, comprise:
deducing a mathematical representation of dynamic resilience region; and
solving the dynamic resilience region based on the resilience cut line.

7. The method of claim 6, wherein deducing the mathematical representation of dynamic resilience region, comprises:
for a certain disaster scenario, determining a variable 0-1 in the optimized urban power system three-stage model, wherein the constraint conditions of the three-stage model can be written in a compact form as shown in equation (24);
$$A θ + B x \leq c \qquad ( 24 )$$
where A and B are coefficients of θ and x, and c represents a constant in the model; the dynamic resilience region is described as that when key parameters are within the dynamic resilience region, there is always a corresponding x in the power system; when the key parameters are outside the dynamic resilience region, there is no x that makes equation (24) valid; the dynamic resilience region is represented by Φ_{θ}^{DRR}:
$${Φ}_{θ}^{DRR} = \{ θ \vert ∃ x : A θ \leq c - B x \} \qquad ( 25 )$$
determining whether a given θ is within the dynamic resilience region depends on whether the corresponding x exists:
$$H ( x ) = \{ x \vert A θ \leq c - B x \} \qquad ( 26 )$$
in the equation, H is a set composed of x, and a physical meaning of equation (26) is that a scheduling strategy x for the urban power grid that satisfies the key parameter θ;
based on robust optimization, positive relaxation variables are used to represent whether all the θ in the current set are within the dynamic resilience region, the physical meaning indicates whether a farthest point in a current optimization space Φ is within the dynamic resilience region, and if R(θ)=0, it indicates that the current optimization space is in the dynamic resilience region, otherwise, it indicates that θ is outside the dynamic resilience region, that is, the current optimization space is larger than the dynamic resilience region;
$$R ( θ ) = {max}_{θ ∈ Φ} {min}_{{r}^{+} \geq 0 , {r}^{-} \geq 0 , x} {1}^{T} {r}^{+} + {1}^{T} {r}^{-} s . t . Bx + {Ir}^{+} - {Ir}^{-} \leq c - A θ \qquad ( 27 )$$
in the equation, R(θ) is used to represent whether all the θ in the current set Φ are within the dynamic resilience region, that is, R(θ)=0 and H are equivalent to non-empty sets, 1 and I are set vectors of corresponding dimensions, and r⁺ and r⁻ are positive slack variables;
since a two-layer optimization problem shown in equation (27) is difficult to be solved by existing commercial solvers, based on a KKT condition and theorem of strong coexistence, the two-layer optimization problem is deduced as an MPLP problem:
$$R ( θ ) = {max}_{θ , d} {d}^{T} ( c - A θ ) s . t . H θ \leq h , - 1 \leq d \leq 0 , {B}^{T} d = 0 \qquad ( 28 )$$
where d is a dual multiplier of inner-layer optimization problem in equation (27), and equation (28) can be written as equation (29) because there is no coupling relationship between d and θ:
$$R ( θ ) = {max}_{d} ( {d}^{T} c + {max}_{θ} ( - {d}^{T} A θ ) ) s . t . H θ \leq h , - 1 \leq d \leq 0 , {B}^{T} d = 0 \qquad ( 29 )$$
according to the theorem of strong coexistence, −d^{T}Aθ is converted into h^{T}μ, and the KKT condition is introduced to ensure optimality:
$$R ( θ ) = {max}_{d , μ , θ} ( {d}^{T} c + {h}^{T} μ ) s . t . - 1 \leq d \leq 0 , {B}^{T} d = 0 , {μ}^{T} ( h - H θ ) = 0 , {A}^{T} d + {H}^{T} μ = 0 \qquad ( 30 )$$
since the KKT condition is introduced to nonlinear terms, the nonlinear terms are linearized by a big M method:
$$R ( θ ) = {max}_{d , μ , θ} ( {d}^{T} c + {h}^{T} μ ) s . t . - 1 \leq d \leq 0 , {B}^{T} d = 0 , {A}^{T} d + {H}^{T} μ = 0 , - M ω \leq ( h - H θ ) \leq 0 , - M ( 1 - ω ) \leq μ \leq 0 \qquad ( 31 )$$
where μ is a dual multiplier of the inner-layer optimization problem in equation (29), and equation (31) is an MILP problem which can be solved by commercial solvers.

8. The method of claim 6, wherein solving the dynamic resilience region based on the resilience cut line, comprises:
when θ=θ₀, if θ₀ is in the dynamic resilience region, it shall satisfies equation (32):
$${d}^{* T} c - {d}^{* T} A {θ}_{0} \leq 0 \qquad ( 33 )$$
in the equation, d* is an optimal solution of equation (31), and d* is a vertex of dual space −1≤d≤0, B^{T}d=0, and thus the dynamic resilience region can be described as (33):
$${Φ}_{θ}^{DRR} = \{ θ \vert {d}^{* T} c \leq {d}^{* T} A θ , {d}^{*} ∈ D \} \qquad ( 34 )$$
in the equation, D is a set of vertices of the dual space, and if θ is outside the dynamic resilience region, it shall satisfies the equation (34):
$${d}^{* T} c > {d}^{* T} A θ , θ ∉ {Φ}_{θ}^{DRR} \qquad ( 35 )$$
equation (36) defines a hyper-plane that separates the dynamic resilience region and a non-dynamic resilience region, which can be defined as a resilience cut line:
$${d}^{* T} c = {d}^{* T} A θ \qquad ( 36 )$$
wherein a solution process of the dynamic resilience region is as follows: firstly, defining a large enough optimization space Φ; solving equation (31), if R(θ)=0, it indicates that a current optimization space is an accurate dynamic resilience region, if R(θ) is not 0, it indicates that the non-dynamic resilience region in the current optimization space still needs to be removed; and calculating equation (36) to obtain a resilience cut line, and add the constraint d*^{T}Aθ≤d*^{T}c corresponding to the cut line to the Φ to obtain an updated optimization space until R(θ)=0.

9. The method of claim 1, wherein based on the urban power system three-stage model, using the shortest distance from the current operating point to the boundary of the dynamic resilience region to represent the dynamic safety margin of the urban power system under the current disaster prediction scenario, comprises:
introducing a positive slack variable to quantify and represent the dynamic safety margin, as shown in equation (37):
$${S}_{t} = {min}_{{s}^{+} \geq 0 , {s}^{-} \geq 0} {1}^{T} {s}^{+} + {1}^{T} {s}^{-} s . t . {H}_{t} {θ}_{0} + {Is}^{+} - {Is}^{-} \geq {h}_{t} , ∀ t ∈ {ϕ}^{T} \qquad ( 37 )$$
wherein a physical meaning of equation (37) is: a minimum change required in the constraints to push important load operating points in a current dynamic resilience region to move beyond a safety boundary.

10. A fast calculation device for a dynamic resilience region of an urban power system, comprising:
a constructing module, configured to construct an urban power system three-stage model applicable for multiple types of public safety events by considering security constraints before, during, and after a disaster, to minimize a three-stage operation cost and a load shedding amount of an urban power grid;
a solving module, configured to, based on the urban power system three-stage model, define a boundary between a resilience region and a non-resilience region as a resilience cut line, and remove the non-resilience region from outside to quickly obtain the dynamic resilience region;
a predicting module, configured to, based on the urban power system three-stage model, use a shortest distance from a current operating point to the boundary of the dynamic resilience region to represent a dynamic safety margin of the urban power system under a current disaster prediction scenario; and
a processing module, configured to, formulate strategies of the urban power system based on the safety margin, comprises at least one of: deploy mobile energy storage of the urban power system for critical loads in scenarios where the safety margin of nodes where the critical loads are located is low before a disaster; and/or, adjust an active output of generating sets of the urban power system, the active output of distributed resources of the urban power system, and the load shedding amount of the nodes of the urban power system so that critical nodes of the urban power system are operated in a position with a highest safety margin to avoid overloads during a disaster.
